(19) United States
(12) Patent Application Publication
(10) Pub. No.: US 2026/0370489 A1
(43) Pub. Date: Nov. 19, 2026

(54) DEVICE AUTHENTICATION METHOD AND APPARATUS BASED ON BLUETOOTH CONNECTION

(71) Applicant: Feitian Technologies Co., Ltd., Beijing (CN)

(72) Inventor: Zhou LU, Beijing (CN)

(73) Assignee: Feitian Technologies Co., Ltd., Beijing (CN)

(21) Appl. No.: 19/143,873

(22) PCT Filed: Oct. 31, 2023
(86) PCT No.: PCT/CN2023/128927

§ 371 Date: Jun. 26, 2025

(30) Foreign Application Priority Data
Dec. 30, 2022 (CN) 202211734244.3

(51) Int. Cl. H04L 9/32; H04W 12/50

(52) U.S. Cl. CPC H04L 9/3247; H04W 12/50

(57) ABSTRACT

A device authentication method device based on a Bluetooth connection, including: a first device determines and parses Bluetooth broadcast data corresponding to a second device, obtains first data, and establishes the Bluetooth connection between the first device and the second device; generates to-be-verified data according to the first data and sends to the second device; the second device verifies the to-be-verified data, if a verification is successful, maintains the Bluetooth connection and completes authentication of the first device; the first device sends a request for Bluetooth characteristic value processing to the second device; the second device obtains target data, signs the target data to generate a signature result, and returns the signature result as a response result to the first device; the first device performs a signature verification on the signature result; if the signature verification is successful, maintains the Bluetooth connection and completes the authentication of the second device.

### CROSS-REFERENCE TO RELATED APPLICATIONS

The present disclosure claims the priority of the Chinese patent application No. 202211734244.3, entitled “DEVICE AUTHENTICATION METHOD AND APPARATUS BASED ON BLUETOOTH CONNECTION” filed with the China National Intellectual Property Administration on Dec. 30, 2022, the entire contents of which are incorporated by reference in the present disclosure.

### TECHNICAL FIELD

The present disclosure relate to the field of information security and, in particular, to a device authentication method and an apparatus based on a Bluetooth connection.

### BACKGROUND

Currently, when two-way authentication is adopt between devices with a Bluetooth connection manner, identity authentication is completed through a manner of command interaction. A device authentication method by means of the command interaction has a bureaucratic procedure and slow authentication speed. How to provide a simple device authentication method to improve the authentication speed has become an urgent technical problem to be solved.

### SUMMARY

Embodiments of the present disclosure provides a device authentication method and an apparatus based on a Bluetooth connection. And technical solutions are as following.

In a first aspect, an embodiment of the present disclosure provides a device authentication method based on a Bluetooth connection, where the method includes:
Step S1: parsing, by a first device, scanned Bluetooth broadcast data, and determining, according to a Bluetooth name obtained by parsing, the Bluetooth broadcast data corresponding to a second device, where the Bluetooth broadcast data corresponding to the second device includes a first random number generated by the second device;
Step S2: parsing, by the first device, the Bluetooth broadcast data corresponding to the second device to obtain first data, and establishing the Bluetooth connection between the first device and the second device;
Step S3: generating, by the first device, to-be-verified data according to the first data obtained by parsing, and sending the to-be-verified data to the second device;
Step S4: verifying, by the second device, the to-be-verified data using the first random number saved by the second device, if a verification is successful, determining that the first data obtained by parsing is the first random number generated by the second device, maintaining the Bluetooth connection, and completing authentication of the first device; if the verification fails, returning an authentication failure response and disconnecting the Bluetooth connection;
Step S5: sending, by the first device, a request for Bluetooth characteristic value processing to the second device, where the Bluetooth characteristic value processing includes reading a Bluetooth characteristic value and writing the Bluetooth characteristic value;
Step S6: acquiring, by the second device, target data, signing the target data to generate a signature result, and returning the signature result as a response result to the first device;
Step S7: performing, by the first device, a signature verification on the signature result, if the signature verification is successful, maintaining the Bluetooth connection and completing authentication of the second device; if the signature verification fails, returning the authentication failure response and disconnecting the Bluetooth connection.

In a second aspect, an embodiment of the present disclosure provides a device authentication apparatus based on a Bluetooth connection, the apparatus is applied to a first device and a second device, where the apparatus includes a data scanning module, a data parsing module, a verification data generating module, a first authenticating module, a request sending module, a signature generating module, and a second authenticating module, the data scanning module, the data parsing module, the verification data generating module, the request sending module, and the second authenticating module are applied to the first device, and the first authenticating module and the signature generating module are applied to the second device;
the data scanning module is configured to parse Bluetooth broadcast data scanned by the first device, and determine Bluetooth broadcast data corresponding to the second device based on a Bluetooth name obtained by parsing; where the Bluetooth broadcast data corresponding to the second device includes a first random number generated by the second device;
the data parsing module is configured to parse the Bluetooth broadcast data corresponding to the second device to obtain first data, and establish a Bluetooth connection between the first device and the second device;
the verification data generating module is configured to generate to-be-verified data according to the first data obtained by parsing, and send the to-be-verified data to the second device;
the first authenticating module is configured to verify the to-be-verified data using a first random number saved by itself; if a verification is successful, determine that the first data obtained by parsing is the first random number generated by the second device, maintain the Bluetooth connection, and complete authentication of the first device; if the verification fails, return an authentication failure response and disconnect the Bluetooth connection;
the request sending module is configured to send a request for Bluetooth characteristic value processing to the second device, where the request for Bluetooth characteristic value processing includes reading a Bluetooth characteristic value and writing the Bluetooth characteristic value;
the signature generating module is configured to obtain target data, sign the target data to generate a signature result, and return the signature result as a response result to the first device;
the second authenticating module is configured to perform a signature verification on the signature result; if the signature verification is successful, maintain the Bluetooth connection and completing the authentication of the second device; if the signature verification fails, return the authentication failure response and disconnect the Bluetooth connection.

In a third aspect, an embodiment of the present disclosure provide a computer-readable storage medium storing a computer program, where the computer program implements the steps of any of the above methods when executed by a processor.

In a fourth aspect, an embodiment of the present disclosure provides an authentication device, including a memory, a processor, and a computer program stored on the memory and executable on the processor; the processor implements the steps of any of the above methods when executes the computer program.

Beneficial effects brought by a technical solution provided in some embodiments of the present disclosure include at least:
in the device authentication method based on the Bluetooth connection provided by the present disclosure, the second device broadcasts the Bluetooth broadcast data containing random numbers through Bluetooth broadcast, and the first device obtains the random numbers from the received Bluetooth broadcast data to implement a device identity authentication, which reduces interaction between the two devices, simplifies device authentication process, and improves authentication speed. Moreover, in the present disclosure, the first device achieves the identity authentication of the second device by sending the request for Bluetooth characteristic value processing, which can further optimize the authentication speed for the device after the Bluetooth connection.

### BRIEF DESCRIPTION OF DRAWINGS

In order to provide a clearer explanation of technical solutions in embodiments of the present disclosure or the prior art, a brief introduction will be given to accompanying drawings required for a description of the embodiments or prior art. It is obvious that the accompanying drawings described below are only some embodiments of the present disclosure. For those skilled in the art, other accompanying drawings can be obtained based on these accompanying drawings without creative labor.

FIG. 1 is a flowchart diagram of a device authentication method based on a Bluetooth connection provided by an embodiment of the present disclosure.

FIG. 2 is a flowchart diagram of another device authentication method based on a Bluetooth connection provided by an embodiment of the present disclosure.

FIGS. 3 to 4 are flowchart diagrams of another device authentication method based on a Bluetooth connection provided by an embodiment of the present disclosure.

### DESCRIPTION OF EMBODIMENTS

In order to clarify purposes, technical solutions, and advantages of the present disclosure, a further detailed description of the embodiments of the present disclosure will be provided below in conjunction with accompanying drawings.

When referring to the accompanying drawings, unless otherwise indicated, the same numbers in different accompanying drawings represent the same or similar elements. Implementations described in the following exemplary embodiments do not represent all implementations consistent with the present disclosure. On the contrary, they are only examples of devices and methods consistent with some aspects of the present disclosure as described in accompanying claims.

In the present disclosure, it should be understood that terms “first”, “second” and the like are only used for descriptive purposes and cannot be understood as indicating or implying relative importance. For those ordinary skilled in the art, specific meanings of the above terms in the present disclosure can be understood in specific situations. In addition, in the description of the present disclosure, unless otherwise specified, “multiple” refers to two or more. “And/or” describes an association relationship between related objects, indicating that there can be three types of relationships, for example, A and/or B, which can represent: A exists alone, A and B exist simultaneously, and B exists alone. A character “/” generally indicates that the associated object before and after is an “or” relationship.

A device authentication method based on a Bluetooth connection provided by an embodiment of the present disclosure will be described in detail as follows.

The device authentication method based on the Bluetooth connection provided by the embodiment of the present disclosure may include the following steps:
Step S-A1: a first device parses scanned Bluetooth broadcast data, and determines Bluetooth broadcast data corresponding to a second device according to a Bluetooth name obtained by parsing, the Bluetooth broadcast data corresponding to the second device includes a first random number generated by the second device;
Step S-A2: the first device parses the Bluetooth broadcast data corresponding to the second device to obtain first data, and establishes a Bluetooth connection between the first device and the second device.

Specifically, the first device establishes the Bluetooth connection with the second device by calling an interface mBluetoothGatt=mBluetoothDevice.connectGatt (mContext( ), false, bluetoothGattCallback, BluetoothDevice.TRANSPORT_LE).
Step S-A3: the first device generates to-be-verified data according to the first data obtained by parsing, and sends the to-be-verified data to the second device;
Step S-A4: the second device verifies the to-be-verified data using the first random number saved by itself; if a verification is successful, determines that the first data obtained by parsing is the first random number generated by the second device, maintains the Bluetooth connection, and completes authentication of the first device; if the verification fails, returns an authentication failure response and disconnects the Bluetooth connection.

Specifically, the first device disconnects the Bluetooth connection from the second device via calling the interface mBluetoothGatt.disconnect( ).
Step S-A5: the first device sends a request for Bluetooth characteristic value processing to the second device, and the request for Bluetooth characteristic value processing includes reading a Bluetooth characteristic value and writing the Bluetooth characteristic value;
where processing operations for reading the Bluetooth characteristic value and writing the Bluetooth characteristic value are different, namely: performing a reading operation for the Bluetooth characteristic value through mBluetoothGatt.readCharacteristic (characteristic); and performing a writing operation for the Bluetooth characteristic value through mBluetoothGatt.writeCharacteristic (characteristic).
Step S-A6: the second device acquires target data, signs the target data to generate a signature result, and returns the signature result as a response result to the first device;
Step S-A7: the first device performs a signature verification on the signature result, if the signature verification is successful, maintains the Bluetooth connection and completes authentication of the second device; if the signature verification fails, returns the authentication failure response and disconnects the Bluetooth connection.

In the device authentication method based on the Bluetooth connection provided by the present disclosure, the second device broadcasts the Bluetooth broadcast data containing random numbers through Bluetooth broadcast, and the first device obtains the random numbers from the received Bluetooth broadcast data to implement a device identity authentication. A manner of broadcasting the random numbers through Bluetooth can reduce one time of interaction between the two devices, simplify the device authentication process, and improve authentication speed. Moreover, in the present disclosure, the first device achieves the identity authentication of the second device by sending the request for Bluetooth characteristic value processing, which can further optimize the the device authentication speed after the Bluetooth connection.

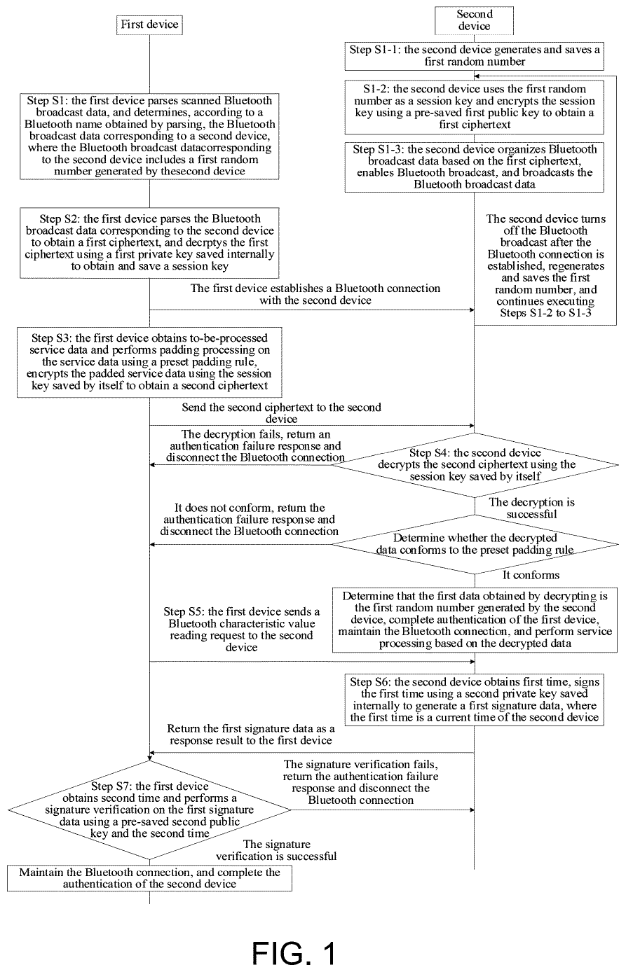

Please refer to FIG. 1, which is a flowchart diagram of a device authentication method based on a Bluetooth connection provided by an embodiment of the present disclosure.

As shown in FIG. 1, the method disclosed in the embodiment of the present disclosure may include the following steps:
Step S1-1: a second device generates and saves a first random number.

For example, the first random number generated by the second device is:
0X52,0X79,0X76,0X49,0X32,0X6A,0X49,0X59
Step S1-2: the second device uses the first random number as a session key and encrypts the session key using a pre-saved first public key to obtain a first ciphertext.

For example, the first public key PUB2 is:
123331
and the first ciphertext is:
0x16,0x1c,0x97,0×8c,0xb0,0x0b,0x65,0x0c,0x56,0x26,0xc0,0x51,0xfb,0x35,0x18,0x4A
Step S1-3: the second device organizes Bluetooth broadcast data based on the first ciphertext, enables Bluetooth broadcast, and broadcasts the Bluetooth broadcast data.

For example, Bluetooth broadcast data is:
0D03000000800C25AAD6BE898E40231CF6F2965C67020102070946545F4543521107161C978CB00B650C5626C051FB35184A47D05
data fields include:
an access address: 0x8E89BED6
a Bluetooth name: 0x46545F454352
a broadcast address: 0x675C96F2F61C
a broadcast carrying service UUID: 0x161C978CB00B650C5626C051FB35184A; 0x161C978CB00B650C5626C051FB35184A is a storage field for the first ciphertext.
Step S1: the first device parses the scanned Bluetooth broadcast data and determines, according to a Bluetooth name obtained by parsing, the Bluetooth broadcast data corresponding to the second device, the Bluetooth broadcast data corresponding to the second device includes the first random number generated by the second device.

In the embodiment of the present disclosure, the first device is a terminal and the second device is a data receiving device.
Step S2: the first device parses the Bluetooth broadcast data corresponding to the second device to obtain a first ciphertext, decrypts the first ciphertext using a first private key saved internally to obtain the session key, and saves the session key, and the first device establishes a Bluetooth connection with the second device.

For example, the first private key PRV2 is:
76895

It should be specially noted that, after the first device establishes the Bluetooth connection with the second device, further including:
the second device turns off the Bluetooth broadcast, regenerates the first random number and saves it, and continues executing Steps S1-2 to S1-3.

After the Bluetooth connection between the first device and the second device is successfully, the second device needs to generate a new first random number for a next broadcast.

For example, the new first random number is:
0x45,0x89,0x36,0xAB,0x24,0xE7,0x25,0x72
Step S3: the first device obtains to-be-processed service data and performs padding processing on the service data using a preset padding rule, encrypts the padded service data using the session key saved by itself to obtain a second ciphertext, and sends the second ciphertext to the second device.

For example, the service data is:
7B227472616E735F74797065223A313030312C227472616E735F616D6F756E7422 3A312C226F726465725F6E6F223A223132333435363738227D the preset padding rule is: pkcs5 padding.

The second ciphertext is:
7ff3c308cd9529e6afb3ffe4976f5404cefdfb3f2b44ae617437b4f2feed59c47db4582a23fb7895912d09c05b76599b8acc668f5a6a7c531575526506cfa8e2
a Bluetooth data transmission is:
0d 03 1c 3e 02 10 09 1d 55 4b d0 45 a6 12 1b 17 00 04 00 52 2d 00 55 aa 00 01 00 407f f3 c3 08 cd 95 29 e6 af b3 ff e4 97 6f d1 5d 48
0d 03 1c 3e 02 10 09 1d 55 4b d0 45 a6 1e 1b 17 00 04 00 52 2d 00 54 04 ce fd fb 3f 2b 44 ae 61 74 37 b4 f2 fe ed 59 c4 7d b4 52 46 57
0d 03 1c 3e 02 10 09 1d 55 4b d0 45 a6 12 1b 17 00 04 00 52 2d 00 58 2a 23 fb 78 9591 2d 09 c0 5b 76 59 9b 8 a cc 66 8f 5a 6a 4d cc 42
0d 03 1c 3e 02 10 09 17 55 4b d0 45 a6 0e 15 11 00 04 00 52 2d 00 7c 53 15 75 52 6506 cf a8 e2 92 00 cc 33 76 eb 16
the Bluetooth transmission adopts a packet transmission, with a maximum byte count of 20 bytes each time, and data after 0x2d00 bytes of which is transmitted data.

Step S4: the second device decrypts the second ciphertext using the session key saved by itself, if a decryption is successful, determines whether the decrypted data conforms to the preset padding rule, if it does, determines that the first data obtained by decrypting is the first random number generated by the second device, completes the authentication of the first device, maintains the Bluetooth connection, and performs service processing based on the decrypted data; if it does not conform, returns the authentication failure response and disconnects the Bluetooth connection; if the decryption fails, returns the authentication failure response and disconnects the Bluetooth connection.
Step S5: the first device sends a Bluetooth characteristic value reading request to the second device.
Step S6: the second device obtains first time, signs the first time using a second private key saved internally to generate a first signature data, and returns the first signature data as the response result to the first device, where the first time is a current time of the second device.

For example, the first time is:
20221031143030
the second private key PRV1 is:
EFF98C89E2AB7EE72DD33E899AA61DB58B7D922AD1F90502EFF06B5EC1B BC87FD741B843C08BD3D49346B5C61DF471AAB7C69497AC476FBEF88FAD712E1C93A BA564B36EE778A0C5B3C08E3A90FF20379FC0D80CC53546AE3C064DC6254EA8E3BB173587C10C716AC1E99192BBB5C17D8A1117BOB901A99DCCD58CEFFEA83A89
and the first signature data is:
59AF0D55A5990588C66705A2400338EB23E810F22E5090E30030B60A29520AB ECD0385D3CE03FA33E2030A37A418E389CF8858E240B5F752266F6D998BDE77F2E706D F93D0AC7A7F932947D22F33D45617EB1CE7B04DD5CDEDFA569DADB14CB26DA2CDC 6 82E98FF1FEBAE2F4F0DF8011DF996 654AF51C9BE39E4B8B105C17CB6
Step S7: the first device obtains second time and performs a signature verification on the first signature data using a pre-saved second public key and the second time; if the signature verification is successful, maintains the Bluetooth connection, and completes the authentication of the second device; if the signature verification fails, returns the authentication failure response and disconnects the Bluetooth connection, where the second time is the current time of the first device.

For example, the second public key PUB1 is:
9BOA3D43386F220579CD8BA15B3E91712E1F251ED591FAE55F2354DF41FD847C198B5394F2991063295129205624EA2DF4339E14E360D4950BA71E60A2B37E65E27A6ED2178F534054172073BB1FE18938A56BCD6B13F1BA60C2843D87E4013E04EDD068A885D9D3F69C0B9703F2611B69D2B02B9E1226177EEC73EDB8F7C483

In the device authentication method based on the Bluetooth connection provided by the present disclosure, the second device broadcasts the Bluetooth broadcast data containing the random numbers through the Bluetooth broadcast and the first device obtains the random numbers from the received Bluetooth broadcast data to implement a device identity authentication. A manner of broadcasting the random numbers through Bluetooth can reduce one time of interaction between the two devices, simplify device authentication process, and improve authentication speed. Moreover, in the present disclosure, the first device achieves the identity authentication of the second device by reading the Bluetooth characteristic value of the second device, both of two interaction manners, namely broadcasting the random numbers through the Bluetooth and reading the Bluetooth characteristic value of the second device are non-data interactions, which can further optimize the device authentication speed after the Bluetooth connection.

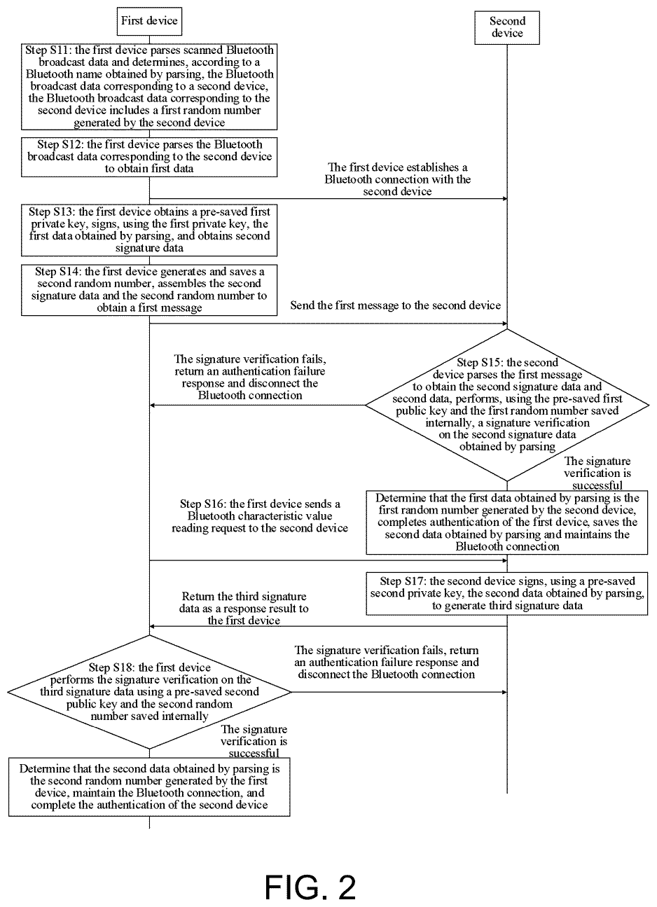

Please refer to FIG. 2, which is a flowchart diagram of another device authentication method based on a Bluetooth connection provided by an embodiment of the present disclosure.

As shown in FIG. 2, the method disclosed in the embodiment of the present disclosure may include the following steps:
Step S11: a first device parses scanned Bluetooth broadcast data and determines, according to a Bluetooth name obtained by parsing, the Bluetooth broadcast data corresponding to a second device, the Bluetooth broadcast data corresponding to the second device includes a first random number generated by the second device.
Step S12: the first device parses the Bluetooth broadcast data corresponding to the second device to obtain first data, and establishes a Bluetooth connection between the first device and the second device.

In an optional embodiment, the first device establishes the Bluetooth connection with the second device, including:
Step S12-1: the first device performs a Bluetooth paring with the second device; if the pairing is successful, the first device establishes a one-way Bluetooth connection with the second device, and executes Step S12-2; otherwise, returns an authentication failure response;
Step S12-2: the second device calls a target interface for the Bluetooth connection; if a connection is successful, the second device establishes a bidirectional Bluetooth connection with the first device, and executes Step S13; otherwise, returns a bidirectional Bluetooth connection failure response, and executes Step S13.

Specifically, the second device establishes the Bluetooth connection with the first device by calling an interface mBluetoothGattServer.connect(device, false).

Based on a successful Bluetooth connection result in Step S12-1, the second device can obtain a connected device object and establish the bidirectional Bluetooth connection with the first device by calling the target interface.

The bidirectional Bluetooth connection allows the second device to listen for Bluetooth disconnection status.

When the second device fails to establish the Bluetooth connection with the first device through the interface, the first device and the second device can still complete a two-way authentication through a processing procedure after Step S13.

The target interface called by the second device is, for example:
BluetoothGattServer.connect(BluetoothDevice, false) Step S13: the first device obtains a pre-saved first private key, signs, using the first private key, the first data obtained by parsing, and obtains second signature data.

For example, the first private key is:
FB6CDDC4E85A83EF110FAAEE7FB206819534F074A2739DF799F7EACC4C1E 43BDF794394CB6890FA5F789CD987498547671B83D3E166754094F04C1851E161C978CB00B650C5626C051FB335CE1891BC1DB5306F4FB572323416E04901BAFAE05E7C57576266809C970CB616B5DA44A14166458AA95A984911487040A7B2A8BA3
the second signature data is:
84AA465953B82387AB55692F4E79E626FE0CE2536238F2B7FAF985420088CF32C8684325A4603C9DE0D24555AA09A5CDC27AFBAE84D0E09BA13E3093D017803751A B842C7DA9B6D8A392308748634DC65725A2B1C897EC04101673AE3FC6381CD3A5E3A7CC5DEBC4A575D152111A6F7E1810E95B03EF4C7FC1D66EDD495F0073
Step S14: the first device generates and saves a second random number, assembles the second signature data and the second random number to obtain a first message, and sends the first message to the second device.

For example, the second random number is:
0x4a,0x4c,0x36,0x6a,0x33,0x43,0x34,0x43
the first message is:
84AA465953B82387AB55692F4E79E626FE0CE2536238F2B7FAF985420088CF32C8684325A4603C9DE0D24555AA09A5CDC27AFBAE84D0E09BA13E3093D017803751A B842C7DA9B6D8A392308748634DC65725A2B1C897EC04101673AE3FC6381CD3A5E3A7CC5DEBC4A575D152111A6F7E1810E95B03EF4C7FC1D66EDD495F00734A4C366A33433443
Step S15: the second device parses the first message to obtain the second signature data and second data, performs, using the pre-saved first public key and the first random number saved internally, a signature verification on the second signature data obtained by parsing; if the signature verification is successful, determines that the first data obtained by parsing is the first random number generated by the second device, completes authentication of the first device, saves the second data obtained by parsing and maintains the Bluetooth connection; if the signature verification fails, returns the authentication failure response and disconnects the Bluetooth connection.

For example, the first public key is:
8A2C6F511209EA13C731A26B3A4C759F3E80C553F3B1A3F33BEEFF787200155457B200FEB989566B97B9C902BBAB39AC7F5A5574BDC71B55BECAF6131B03A4FA2C BFCA0E854EFE142BC1FBBA49DAA487409BACC6C05B10C42B10FEF972535019859186E F4898C73EB63E7FBC198DA711054E5EAC719F18AEFF56885B67603125

The performing, using the pre-saved first public key and the first random number saved internally, a signature verification on the second signature data obtained by parsing, specifically including:
the second device decrypts, using the pre-saved first public key, the second signature data obtained by parsing, to obtain a first hash value;
the second device performs a hash operation on the first random number saved internally to obtain a second hash value;
the second device determines whether the first hash value is the same as the second hash value; if they are the same, the signature verification is successful, saves the second random number obtained by parsing and maintains the Bluetooth connection, and completes the authentication of the first device; if they are not the same, the signature verification fails, returns the authentication failure response, and disconnects the Bluetooth connection.

Specifically, the second device disconnects the Bluetooth connection from the first device via calling an interface mBluetoothGattServer.cancelConnection(entry.getValue( )).
Step S16: the first device sends a Bluetooth characteristic value reading request to the second device.
Step S17: the second device signs, using a pre-saved second private key, the second data obtained by parsing, to generate third signature data, and returns the third signature data as the response result to the first device.

For example, the third signature data is:
E9B0B9D2257CBACC49202D6DA7772957EBEBDA17414967EBCB49965BE91A 0D6D8FAD36BE1FA424A213BFE0088401792AA269793403E7C0808D1FC572E217973E543B86F6684F1697CEF8047BA05EC31969FF42B724489221E9FD69D808EE1515F4B7A34CD9C52D250D2DFA76E4F0B5E0E99313872ACB81634705B2BA3C16B023
Step S18: the first device performs the signature verification on the third signature data using a pre-saved second public key and the second random number saved internally. If the signature verification is successful, determines that the second data obtained by parsing is the second random number generated by the first device, maintains the Bluetooth connection, and completes the authentication of the second device; if the signature verification fails, returns the authentication failure response and disconnects the Bluetooth connection.

The signature verification process of the third signature data in this step can refer to Step S15 for details, which will not be repeated here.

In the device authentication method based on the Bluetooth connection provided by the present disclosure, the second device broadcasts the Bluetooth broadcast data containing the random numbers through Bluetooth broadcast, and the first device obtains the random numbers from the received Bluetooth broadcast data to implement a device identity authentication. A manner of broadcasting the random numbers through Bluetooth can reduce one time of interaction between the two devices, simplify the device authentication process, and improve authentication speed. Moreover, in the present disclosure, the first device achieves the identity authentication of the second device by reading the Bluetooth characteristic value of the second device, both of two interaction manners, namely broadcasting the random numbers through the Bluetooth and reading the Bluetooth characteristic value of the second device are non-data interactions, which can further optimize the device authentication speed after the Bluetooth connection.

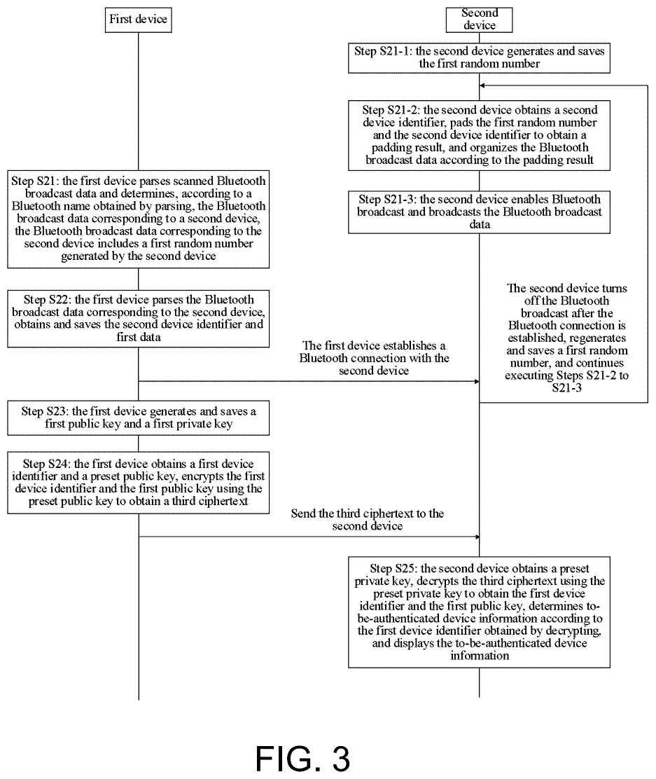

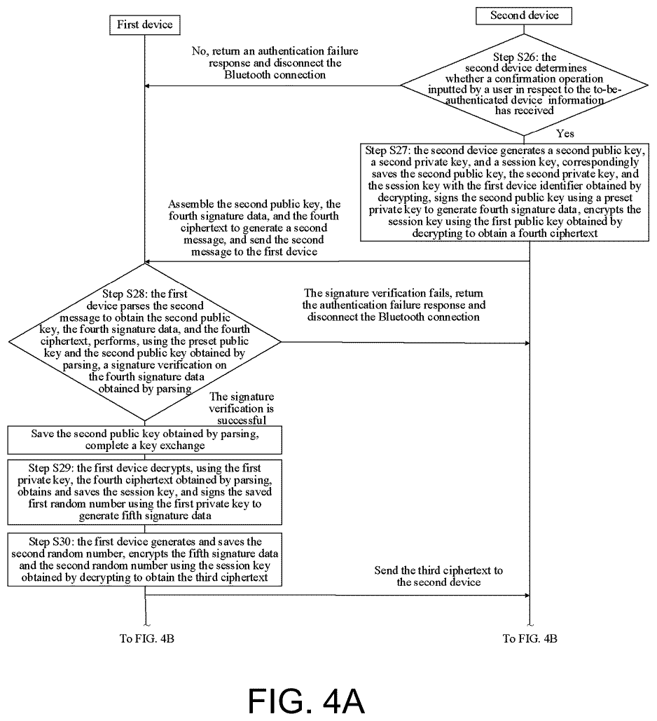

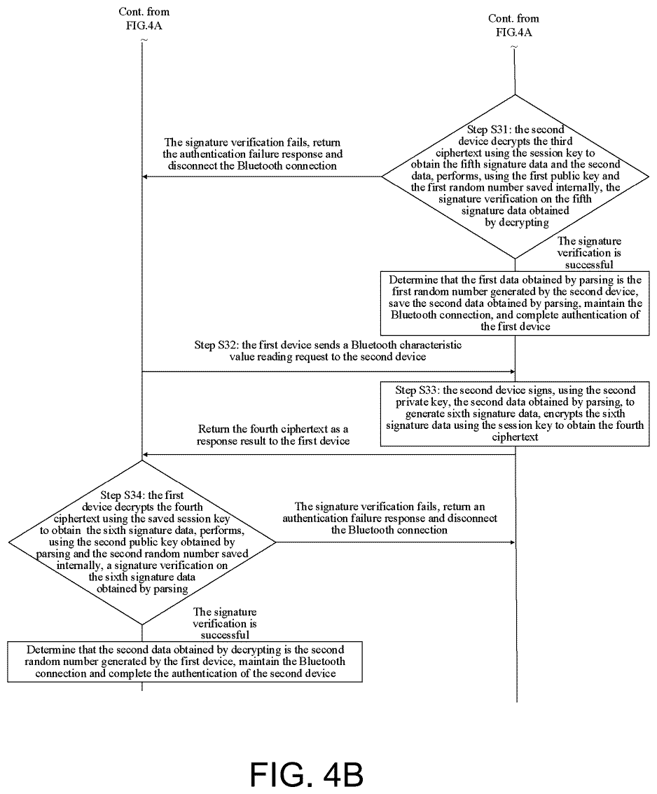

Please refer to FIGS. 3 to 4, which illustrate flowchart diagrams of another device authentication method based on a Bluetooth connection provided by an embodiment of the present disclosure.

This embodiment includes key exchange process before a device authentication.

As shown in FIGS. 3 to 4, the method of this embodiment includes the following steps:
Step S21: a first device parses scanned Bluetooth broadcast data and determines, according to a Bluetooth name obtained by parsing, Bluetooth broadcast data corresponding to a second device, the Bluetooth broadcast data corresponding to the second device includes a first random number generated by the second device.

In the optional embodiment, before Step S21, further including:
Step S21-1: the second device generates and saves the first random number.

For example, the first random number generated by the second device is: 0x52,0x79,0x76,0x49,0x32,0x6A,0x49,0x59
Step S21-2: the second device obtains a second device identifier, pads the first random number and the second device identifier to obtain a padding result, and organizes the Bluetooth broadcast data according to the padding result.
Step S21-3: the second device enables Bluetooth broadcast and broadcasts the Bluetooth broadcast data.
Step S22: the first device parses the Bluetooth broadcast data corresponding to the second device, obtains and saves the second device identifier and first data, the first device establishes a Bluetooth connection with the second device.

It should be noted that, after the first device establishes the Bluetooth connection with the second device, further including:
the second device turns off the Bluetooth broadcast, regenerates and saves a first random number, and continues with Steps S21-2 to S21-3.

After the first device successfully establishes the Bluetooth connection with the second device, the second device needs to generate a new first random number for next broadcast.
Step S23: the first device generates and saves a first public key and a first private key.
Step S24: the first device obtains a first device identifier and a preset public key, encrypts the first device identifier and the first public key using the preset public key to obtain a third ciphertext, and sends the third ciphertext to the second device.

For example, the first device identifier is:
0x56,0x65,0x03,0xF0,0x56,0x60
the preset public key is:
BD96AE42F4AF67BD3C5E54FBB5928020FC7B8F3FFA115D9C7C20F2DD7AFA 34411E3251D11758D92443AD45B6C8295A757C5820316D00DE0391F14A5430DE23F8CB3C2CAD9724EE92A13A9AFD213E34A79F1E07D4A2D716B45D144E8E23F133A4A7B824F 1803BBDE5D6313BC096A8426EC346435D3BC2C482015CDE1F660C1EFD
and the third ciphertext is:
81E8D6145F5930B477ACD16B8AFFD8C64D4CB6F362B1A5D1EE25AC59D2448F1C537E2EBA1AC739E6500F4B2F1B15E44F0DCB32E32FFE2A4EDD842276BC020AF762981755F20C22BDFA03BBA023563B9EF8A4B96F4B12CAE92391BD872357A76897E5EC0373531AB4574D14F74F437B23D5D4C86C00443688CF8D1DB64573F149
Step S25: the second device obtains a preset private key, decrypts the third ciphertext using the preset private key to obtain the first device identifier and the first public key, determines to-be-authenticated device information according to the first device identifier obtained by decrypting, and displays the to-be-authenticated device information.

For example, the preset private key is:
FA7554B7FB900067E23B94B02BC118187AE5D3375BFDCFD1A7826FA089E30506FD6505603743C0B3DDB39E1BCCC065A14308297AD2788CE609081AC690A205EBC1C 890DCD87EC24B315AD5339D5039660D82088DF2CA675961127DE40E6B8AC13B65597569EE8D02BB11B9D10EAD55B90D2A696DCB3E450B72EB49BAA2C0ACB7

The preset public and private keys in this embodiment are pre-written in the device.

For example, the to-be-authenticated device information includes a first device name and the like.

Step S26: the second device determines whether a confirmation operation inputted by a user in respect to the to-be-authenticated device information has received. If so, executes Step S27; if not, returns an authentication failure response and disconnects the Bluetooth connection.

Step S27: the second device generates a second public key, a second private key, and a session key, correspondingly saves the second public key, the second private key, and the session key with the first device identifier obtained by decrypting, signs the second public key using a preset private key to generate fourth signature data, encrypts the session key using the first public key obtained by decrypting to obtain a fourth ciphertext, assembles the second public key, the fourth signature data, and the fourth ciphertext to generate a second message, and sends the second message to the first device.

For example, the session key is:
BA27E8106C2100B60F8100F104CE7E32FF3A2EE6AF40C7CA
the fourth signature data is:
0CBFC7E90AB40C9DB5D045F593CBED1E376B9F11446630C9CADAFAA7018820AF75CCC73D74C00F59C0C3A8C99BA7665F38490784FBC944E171FC3FA473C691B81A 517347B022DE6D52F2FAC1D239F5E81A8A4F072CD38C829FCDB9CADF81D53EF86081AAD24AA261A4A06D8265B08B6B81C9FD66DAE5F2A2B0D3382609C88781
and the fourth ciphertext is:
36A43F0DF760860A169C770317C813BF1B986188AED490541420857C9AC5FE7B141D2AF956A7683F19FE1410B9A2A530ED0CC00EF2366FCDB3ED23A6D27967F0C481D1966C7388535064898DBE9575828C8BFE0D765FEE672FEB2D80D38E8A3BEFE679A451D8BF96D9C6E2D8BF149F985DFBD19A930EBFA28F2FC887A21DADF3
Step S28: the first device parses the second message to obtain the second public key, the fourth signature data, and the fourth ciphertext, performs, using the preset public key and the second public key obtained by parsing, a signature verification on the fourth signature data obtained by parsing; if the signature verification is successful, saves the second public key obtained by parsing, completes the key exchange, and executes step S29; if the signature verification fails, returns the authentication failure response and disconnects the Bluetooth connection.

The performing, using the preset public key and the second public key obtained by parsing, a signature verification on the fourth signature data obtained by parsing, specifically including:
Step S28-1: the first device decrypts, using the preset public key, the fourth signature data obtained by parsing, to obtain a third hash value;
Step S28-2: the first device performs a hash operation on the second public key obtained by parsing to obtain a fourth hash value;
Step S28-3: the first device determines whether the third hash value and the fourth hash value are the same. If they are the same, the signature verification is successful, saves the second public key obtained by parsing, completes the key exchange, and executes Step S29; if they are not the same, the signature verification fails, returns the authentication failure response and disconnects the Bluetooth connection.

It should be noted that, the key exchange (i.e. Steps S23 to S28) is an operation that need to be performed when establishing the Bluetooth connection for the first time for both devices. When both devices establish the Bluetooth connection again in the future, there is no need to perform the key exchange, and an authentication operation (Steps S29 to S34) can be directly performed.
Step S29: the first device decrypts, using the first private key, the fourth ciphertext obtained by parsing, obtains and saves the session key, and signs the saved first random number using the first private key to generate fifth signature data.

For example, the fifth signature data is:
35681449630CD46F48EF42FE9C27FFCA52306C2B05AE45D7E2219299A7A116AE51DF0E62C02C6DD1A2A2E8F510A35E8DDB479C21EAECA9A27D2E61099C1303FCF B1B9DE27F1C6D0C603CB56B8CD85C79D29E8874E888E9720D851A861BF721FFFA9060D5DB36DD1C8AC7A3B82848969BBFD41B1B5DCD1B9E7BBCEAB725A07E2B
Step S30: the first device generates and saves the second random number, encrypts the fifth signature data and the second random number using the session key obtained by decrypting, to obtain the third ciphertext, and sends the third ciphertext to the second device.

For example, the second random number is:
0x4A,0x4C,0x36,0x6A,0x33,0x43,0x34,0x43
and the third ciphertext is:
69504176377D339CD9BA181FB20B742356F899084B21BCE27FAD613229949AE A735745E99F7928422F181FDC72A030C20F351509F85A60556BF64E5140037FD7EBDC0C F7A05555BC657419C763C9744AC4B874C95D2E72FF825B82E9EF85E1B30100F7C992DC FD7711402E2236C1E5B468F7D85D61079C21077A39FC30D0CAA579313438534D4732
Step S31: the second device decrypts the third ciphertext using the session key to obtain the fifth signature data and the second data, performs, using the first public key and the first random number saved internally, the signature verification on the fifth signature data obtained by decrypting; if the signature verification is successful, determines that the first data obtained by parsing is the first random number generated by the second device, saves the second data obtained by parsing, maintains the Bluetooth connection, and completes the authentication of the first device; if the signature verification fails, returns the authentication failure response and disconnects the Bluetooth connection.
Step S32: the first device sends a Bluetooth characteristic value reading request to the second device.
Step S33: the second device signs, using the second private key, the second data obtained by parsing, to generate sixth signature data, encrypts the sixth signature data using the session key to obtain the fourth ciphertext, and returns the fourth ciphertext as a response result to the first device.

For example, the third signature data is:
A11BD8910A4B40819577ECB633CFAEE00D15BB7C47371AE67E2FCDE04CDA 8E08165C7C4F06A0543488D5996279B7A71F4EA98BC0584F396A2EF1A9407B5B27F447769D45F8FF6495F38CD9598ACAFBF10BC2B80646DCE4D81A07CFA0EA1BEB37A6BF083D1D4000B2BE2F97F5C5E6922224F16B1E5E7CA7652D69B3894BD11683
and the fourth ciphertext is:
9D4C99C63FA4B99CECA4583E069455483F637FF8B500E7D1A87BCE72A8226195BA36D1DEF3A13CA27F3A5365610DB26477BFC47F710334F3EE1FA27C3EA1E4ED340AD3FE621ED2DD3C726D828D085990FC623E8A1E3B4A655A9193FD39D80896C6A9D5E 0CB1C5851723CFA702A282DDE67923CDD4D65B67C250155E7D577B8D1
Step S34: the first device decrypts the fourth ciphertext using the saved session key to obtain the sixth signature data, performs, using the second public key obtained by parsing and the second random number saved internally, a signature verification on the sixth signature data obtained by decrypting; if the signature verification is successful, determines that the second data obtained by decrypting is the second random number generated by the first device, maintains the Bluetooth connection and completes the authentication of the second device; if the signature verification fails, returns an authentication failure response and disconnects the Bluetooth connection.

The specific verification process for the sixth signature data can refer to Step S28 or Step S31, which will not be repeated here.

It should be noted that, the key exchange and the device authentication are two independent processes, among which the key exchange process is only implemented when both devices establish the Bluetooth connection for the first time; the device authentication includes the authentication of the second device to the first device (i.e., Steps S19 to S21), and the authentication of the first device to the second device (i.e., Steps S22 to S24). The authentication of the second device to the first device is a necessary authentication step before the device processes service, while the authentication of the first device to the second device is a non-necessary authentication step before the device processes service (i.e., the first device can authenticate or not authenticate the second device).

In the device authentication method based on the Bluetooth connection provided by the present disclosure, the second device broadcasts the Bluetooth broadcast data containing the random numbers through Bluetooth broadcast, and the first device obtains the random numbers from the received Bluetooth broadcast data to implement a device identity authentication. A manner of broadcasting the random numbers through Bluetooth can reduce one time of interaction between the two devices, simplify device authentication process, and improve authentication speed. Moreover, in the present disclosure, the first device achieves the identity authentication of the second device by reading the Bluetooth characteristic value of the second device, both of two interaction manners, namely broadcasting the random numbers through the Bluetooth and reading the Bluetooth characteristic value of the second device are non-data interactions, which can further optimize the device authentication speed after the Bluetooth connection.

The following are apparatus embodiments in the present disclosure, which can be used to implement method embodiments in the present disclosure. For details not disclosed in the apparatus embodiment of the present disclosure, please refer to the method embodiment of the present disclosure.

A device authentication apparatus based on a Bluetooth connection provided by an embodiment of the present disclosure is applied to a first device and a second device. The apparatus includes a data scanning module, a data parsing module, a verification data generating module, a first authenticating module, a request sending module, a signature generating module, and a second authenticating module, the data scanning module, the data parsing module, the verification data generating module, the request sending module, and the second authenticating module are applied to the first device, while the first authenticating module and the signature generating module are applied to the second device;
the data scanning module is configured to parse Bluetooth broadcast data scanned by the first device, and determine Bluetooth broadcast data corresponding to the second device based on a Bluetooth name obtained by parsing; where the Bluetooth broadcast data corresponding to the second device includes a first random number generated by the second device;
the data parsing module is configured to parse the Bluetooth broadcast data corresponding to the second device to obtain first data, and establish a Bluetooth connection between the first device and the second device;
the verification data generating module is configured to generate to-be-verified data according to the first data obtained by parsing, and send the to-be-verified data to the second device;
the first authenticating module is configured to verify the to-be-verified data using a first random number saved by itself; if a verification is successful, determine that the first data obtained by parsing is the first random number generated by the second device, maintain the Bluetooth connection, and complete authentication of the first device; if the verification fails, return an authentication failure response and disconnect the Bluetooth connection;
the request sending module is configured to send a request for Bluetooth characteristic value processing to the second device, where the request for Bluetooth characteristic value processing includes reading a Bluetooth characteristic value and writing the Bluetooth characteristic value;
the signature generating module is configured to obtain target data, sign the target data to generate a signature result, and return the signature result as a response result to the first device;
the second authenticating module is configured to perform a signature verification on the signature result; if the signature verification is successful, maintain the Bluetooth connection and complete the authentication of the second device; if the signature verification fails, return the authentication failure response and disconnect the Bluetooth connection.

In an optional embodiment, the data parsing module is configured to:
parse the Bluetooth broadcast data corresponding to the second device to obtain a first ciphertext, decrypt the first ciphertext using a first private key saved internally to obtain the first data, and establish the Bluetooth connection between the first device and the second device;
the verification data generating module is configured to:
obtain to-be-processed service data, and perform padding processing on the service data using a preset padding rule, encrypt the padded service data using the first data obtained by decrypting to obtain a second ciphertext, and send the second ciphertext to the second device;
the first authenticating module is configured to:
decrypt the second ciphertext using the first random number saved by the second device; if a decryption is successful, determine whether decrypted data conforms to the preset padding rule, if it does, determine that the first data obtained by decrypting is the first random number generated by the second device, complete the authentication of the first device, maintain the Bluetooth connection, and perform service processing according to the decrypted data, if it does not conform, return the authentication failure response and disconnect the Bluetooth connection; if the decryption fails, return the authentication failure response and disconnect the Bluetooth connection.

In an optional embodiment, the target data is specifically first time, and the signature generating module is configured to:
obtain the first time, sign the first time using a second private key saved internally to generate first signature data, and return the first signature data as the response result to the first device, where the first time is a current time of the second device;
the second authenticating module is configured to:
obtain second time, perform a signature verification on the first signature data using a pre-saved second public key and the second time; if the signature verification is successful, maintain the Bluetooth connection and complete the authentication of the second device; if the signature verification fails, return the authentication failure response and disconnect the Bluetooth connection, where the second time is the current time of the first device.

In an optional embodiment, the apparatus further includes a random number generating module, a ciphertext generating module, and a data broadcasting module, where the random number generating module, the ciphertext generating module, and the data broadcasting module are used for the second device:
the random number generating module is configured to generate and save the first random number;
the ciphertext generating module is configured to encrypt the first random number using a pre-saved first public key to obtain the first ciphertext;
the data broadcasting module is configured to organize the Bluetooth broadcast data according to the first ciphertext, enable Bluetooth broadcast, and broadcast the Bluetooth broadcast data.

In an optional embodiment, the data parsing module is further configured to:
turn off the Bluetooth broadcast, regenerate and save the first random number, and trigger the ciphertext generating module and the data broadcasting module.

In an optional embodiment, the data parsing module includes:
a pairing unit, configured to perform a Bluetooth pairing; if the pairing is successful, the first device establishes a one-way Bluetooth connection with the second device, trigger a connection unit; otherwise, return the authentication failure response;
the connection unit, configured to call a target interface for the Bluetooth connection; if a connection is successful, the second device establishes a bidirectional Bluetooth connection with the first device, trigger the verification data generating module; otherwise, return a bidirectional Bluetooth connection failure response, and trigger the verification data generating module.

In an optional embodiment, the verification data generating module is configured to:
obtain a pre-saved first private key, sign, using the first private key, the first data obtained by parsing, and obtain second signature data;
generate and save a second random number, assemble the second signature data and the second random number to obtain a first message, and send the first message to the second device;
the first authenticating module is configured to:
parse the first message to obtain the second signature data and second data, perform, using a pre-saved first public key and first random number saved internally, the signature verification on the second signature data obtained by parsing; if the signature verification is successful, determine that the first data obtained by parsing is the first random number generated by the second device, complete the authentication of the first device, save the second data obtained by parsing and maintain the Bluetooth connection; if the signature verification fails, return the authentication failure response and disconnect the Bluetooth connection.

In an optional embodiment, the first authenticating module is configured to:
parse the first message to obtain the second signature data and the second data, decrypt, using a pre-saved first public key, the second signature data obtained by parsing, to obtain a first hash value;
perform a hash operation on the first random number saved internally to obtain a second hash value;
determine whether the first hash value is the same as the second hash value; if they are the same, the signature verification is successful; determine that the first data obtained by parsing is the first random number generated by the second device, complete the authentication of the first device, save the second data obtained by parsing, and maintain the Bluetooth connection; if they are not the same, the signature verification fails, return the authentication failure response, and disconnect the Bluetooth connection.

In an optional embodiment, the target data is specifically the second data obtained by parsing, and the signature generating module is configured to:
sign, using the pre-saved second private key, the second data obtained by parsing, to generate third signature data, and return the third signature data as the response result to the first device;
the second authenticating module is configured to:
perform the signature verification on the third signature data using the pre-saved second public key and the second random number saved internally; if the signature verification is successful, determine that the second data obtained by parsing is the second random number generated by the first device, maintain the Bluetooth connection, and complete the authentication of the second device; if the signature verification fails, return the authentication failure response and disconnect the Bluetooth connection.

It should be noted that, the device authentication apparatus based on the Bluetooth connection provided by the above embodiments only illustrates a division of the above functional modules when executing the based device authentication method based on Bluetooth connection. In practical applications, the above functions can be assigned to different functional modules as needed, that is, an internal structure of the device can be divided into different functional modules to complete all or part of the functions described above. In addition, the embodiments of the device authentication apparatus based on Bluetooth connection and the device authentication method based on Bluetooth connection provided by the above embodiments belong to the same concept, and their implementation process is detailed in the method embodiments, which will not be repeated here.

The above embodiment numbers in the present disclosure are merely used for description and do not represent advantages or disadvantages of the embodiments.

In the device authentication apparatus based on Bluetooth connection provided by the present disclosure, the second device broadcasts Bluetooth broadcast data containing a random number through Bluetooth broadcast, and a first device obtains the random number from the received Bluetooth broadcast data to implement a device identity authentication. A manner of broadcasting the random numbers through Bluetooth can reduce one time of interaction between the two devices, simplify device authentication process, and improve authentication speed. Moreover, the first device in the present disclosure achieves the identity authentication of the second device by reading a Bluetooth characteristic value of the second device, which can further optimize the device authentication speed after the Bluetooth connection.

An embodiment of the present disclosure also provides a computer-readable storage medium, storing a computer program thereon, when the program executed by a processor, implements steps of any of the aforementioned embodiments. Where, the computer-readable storage media can include but are not limited to any type of disks, including floppy disks, optical disks, DVDs, CD ROMs, micro drives, and magneto-optical disks, ROMs, RAMs, EPROMS, EEPROMs, DRAMs, VRAMs, flash memory devices, magnetic or optical cards, nanosystems (including molecular memory ICs), or any type of mediums or devices suitable for storing instructions and/or data.

An embodiment of the present disclosure also provides an authentication device, including a memory, a processor, and a computer program stored on the memory and executable on the processor. When the processor executes the program, the steps of any of the above embodiments are implemented.

An embodiment of the present disclosure provides an authentication device, including a processor and a memory.

In the embodiment of the present disclosure, the processor is a control center of a computer system, which can be the processor of a physical machine or the processor of a virtual machine. The processor can include one or more processing cores, such as a 4-core processor, an 8-core processor and the like. The processor can be implemented in at least one hardware form from DSP (Digital Signal Processing, digital signal processing), FPGA (Field-Programmable Gate Array, field programmable gate array), and PLA (Programmable Logic Array, programmable logic array). The processor can also include a main processor and a co-processor. The main processor is the processor used to process data in an awake state, also known as a CPU (Central Processing Unit, central processing unit); while the co-processor is a low-power processor used to process data in a standby state.

The memory may include one or more computer-readable storage media, which may be non-transient. The memory can also include a high-speed random access memory, as well as a non-volatile memory such as one or more disk storage devices, flash storage devices. In some embodiments in the present disclosure, a non-transient computer-readable storage medium in the memory is used to store at least one instruction, which is configured to be executed by the processor to implement the methods in the present disclosure.

In some embodiments, the authentication device further includes a peripheral device interface and at least one peripheral device. The processor, memory, and peripheral device interfaces can be connected through buses or signal lines. Various peripheral devices can be connected to the peripheral device interface through buses, signal lines, or circuit boards. Specifically, the peripheral device includes at least one of a display screen, a camera, and an audio circuit.

The peripheral device interface can be configured to connect at least one peripheral device related to I/O (Input/Output, input/output) to the processor and memory. In some embodiments of the present disclosure, the processor, memory, and peripheral device interfaces are integrated on the same chip or circuit board; in some other embodiments of the present disclosure, any one or two of the processor, memory, and peripheral device interfaces may be implemented on separate chips or circuit boards. The embodiment of the present disclosure does not provide specific limitations on this.

The display screen is used to show a UI (User Interface, user interface). This UI can include graphics, text, icons, videos, and any combination thereof. When the display screen is a touch screen, it also has a capability to collect touch signals on or above a surface of the display screen. The touch signal can be input as a control signal to the processor for processing. At this point, the display screen can also be used to provide virtual buttons and/or virtual keyboards, also known as soft buttons and/or soft keyboards. In some embodiments of the present disclosure, the display screen may be one, set on a front panel of the authentication device; in some other embodiments of the present disclosure, the display screens may be at least two, respectively set on different surfaces of the authentication device or in a folded design; in some further embodiments of the present disclosure, the display screen may be a flexible display screen set on a curved surface or folding surface of the authentication device. Even, the display screen can be set as a non-rectangular irregular shape, that is, an irregular screen. The display screen can be made of materials such as LCD (Liquid Crystal Display, liquid crystal display) and OLED (Organic Light Emitting Diode, organic light emitting diode).

The camera is configured to capture images or videos. Optionally, the camera includes a front facing camera and a rear facing camera. Usually, the front camera is located on the front panel of a client, and the rear facing camera is located on a back of the client. In some embodiments, there are at least two rear cameras, namely any one of main camera, depth field camera, wide-angle camera, and telephoto camera, in order to achieve background blurring function through achieving a fusion of the main camera and the depth-field camera, panoramic shooting through achieving the fusion of the main camera and the wide-angle camera, VR (Virtual Reality, virtual reality) shooting function, or other fusion shooting functions. In some embodiments of the present disclosure, the camera may also include a flash. The flash can be a monochrome temperature flash or a dual color temperature flash. The dual color temperature flash refers to a combination of a warm light flash and a cool light flash, which can be used for light compensation at different color temperatures.

The audio circuit may include a microphone and a speaker. The microphone is used to collect sound waves from users and the environment, and convert the sound waves into electrical signals that are input to the processor for processing. For a purpose of stereo acquisition or noise reduction, multiple microphones can be set up in different parts of the authentication device. The microphone can also be an array microphone or an omnidirectional acquisition microphone.

A power supply is used to provide power to various components in the authentication device. The power source can be AC, DC, disposable battery, or rechargeable battery. When the power source includes a rechargeable battery, the rechargeable battery can be a wired rechargeable battery or a wireless rechargeable battery. The wired rechargeable battery is a battery charged through wired lines, while the wireless rechargeable battery is the battery charged through wireless coils. This rechargeable battery can also be used to support fast charging technology.

A client architecture diagram shown in an embodiment of the present disclosure does not constitute a limitation on the authentication device. The authentication device may include more or fewer components than shown in the diagram, or combine certain components, or adopt different component arrangements.

In the present disclosure, terms “first”, “second” and the like are used for descriptive purposes only and should not be construed as indicating or implying relative importance or order; the term “multiple” refers to two or more, unless otherwise specified. The terms “installation”, “connection”, “link”, “fixation” and the like should be broadly understood. For example, the “connection” can be a fixed connection, a detachable connection, or an integral connection; the “link” can be directly linked or indirectly linked through an intermediate medium. For ordinary technical personnel in this field, specific meanings of the above terms in the present disclosure can be understood according to the specific situation.

In the description of the present disclosure, it should be understood that orientation or positional relationships indicated by the terms “up”, “down” and the like are orientation or positional relationships based on the accompanying drawings. This is only for the convenience of describing the present disclosure and simplifying the description, and does not indicate or imply that the device or unit referred to must have a specific orientation, be constructed and operated in a specific orientation. Therefore, it cannot be understood as a limitation of the present disclosure.

The above are only specific implementations of the present disclosure, but a protection scope of the present disclosure is not limited to this. Any skilled person familiar with this technical field can easily think of modifications or replacements within a technical scope disclosed in the present disclosure, which should be included in the protection scope of the present disclosure. Therefore, equivalent modifications made according to the claims of the present disclosure still fall within a scope of the present disclosure.

1. A device authentication method based on a Bluetooth connection, wherein the method comprises:
Step S1: parsing, by a first device, scanned Bluetooth broadcast data, and determining, according to a Bluetooth name obtained by parsing, Bluetooth broadcast data corresponding to a second device, wherein the Bluetooth broadcast data corresponding to the second device comprises a first random number generated by the second device;
Step S2: parsing, by the first device, the Bluetooth broadcast data corresponding to the second device to obtain first data, and establishing the Bluetooth connection between the first device and the second device;
Step S3: generating, by the first device, to-be-verified data according to the first data obtained by parsing, and sending the to-be-verified data to the second device;
Step S4: verifying, by the second device, the to-be-verified data using the first random number saved in the second device, if a verification is successful, the first data obtained by parsing by the first device is the first random number generated by the second device, maintaining the Bluetooth connection, and completing authentication of the first device; if the verification fails, returning an authentication failure response and disconnecting the Bluetooth connection;
Step S5: sending, by the first device, a request for Bluetooth characteristic value processing to the second device, wherein the Bluetooth characteristic value processing comprises reading a Bluetooth characteristic value and writing the Bluetooth characteristic value;
Step S6: acquiring, by the second device, target data, signing the target data to generate a signature result, and returning the signature result as a response result to the first device;
Step S7: performing, by the first device, a signature verification on the signature result, if the signature verification is successful, maintaining the Bluetooth connection and completing authentication of the second device; if the signature verification fails, returning the authentication failure response and disconnecting the Bluetooth connection.

2. The method according to claim 1, wherein Step S2 comprises:
parsing, by the first device, the Bluetooth broadcast data corresponding to the second device to obtain a first ciphertext, decrypting the first ciphertext using a first private key saved internally to obtain the first data, and establishing the Bluetooth connection between the first device and the second device;
Step S3 comprises:
obtaining, by the first device, to-be-processed service data, and performing padding processing on the service data using a preset padding rule, encrypting the padded service data using the first data obtained by decrypting to obtain a second ciphertext, and sending the second ciphertext to the second device;
Step S4 comprises:
decrypting, by the second device, the second ciphertext using the first random number saved by the second device, if a decryption is successful, determining whether decrypted data conforms to the preset padding rule; if the decrypted data conforms to the preset padding rule, completing the authentication of the first device, maintaining the Bluetooth connection, and performing service processing according to the decrypted data; if the decrypted data does not conform to the preset padding rule, returning the authentication failure response and disconnecting the Bluetooth connection; if the decryption fails, returning the authentication failure response and disconnecting the Bluetooth connection.

3. The method according to claim 1, wherein the target data is specifically first time, and Step S6 comprises:
obtaining, by the second device, the first time, signing the first time using a second private key saved internally to generate first signature data, and returning the first signature data as the response result to the first device; wherein the first time is a current time of the second device;
Step S7 comprises:
obtaining, by the first device, second time, performing the signature verification on the first signature data using a pre-saved second public key and the second time; if the signature verification is successful, maintaining the Bluetooth connection and completing the authentication of the second device; if the signature verification fails, returning the authentication failure response and disconnecting the Bluetooth connection, wherein the second time is the current time of the first device.

4. The method according to claim 2, wherein before Step S1, the method further comprises:
Step S1-1: generating and saving, by the second device, the first random number;
Step S1-2: encrypting, by the second device, the first random number using a pre-saved first public key to obtain a ciphertext of the first random number;
Step S1-3: organizing, by the second device, the Bluetooth broadcast data according to the ciphertext of the first random number, enabling Bluetooth broadcast, and broadcasting the Bluetooth broadcast data.

5. The method according to claim 4, wherein after establishing a Bluetooth connection between the first device and the second device, the method further comprises:
turning off, by the second device, the Bluetooth broadcast, regenerating and saving a first random number, and continuing to execute Steps S1-2 to S1-3.

6. The method according to claim 1, wherein the establishing the Bluetooth connection between the first device and the second device, comprises:
Step S2-1: performing a Bluetooth paring between the first device and the second device;
if the pairing is successful, establishing, by the first device, a one-way Bluetooth connection with the second device, and executing Step S2-2; otherwise, returning the authentication failure response;
Step S2-2: calling, by the second device, a target interface for the Bluetooth connection; if a connection is successful, establishing, by the second device, a bidirectional Bluetooth connection with the first device and executing Step S3; otherwise, returning a bidirectional Bluetooth connection failure response and executing Step S3.

7. The method according to claim 1, wherein Step S3 comprises:
obtaining, by the first device, a pre-saved first private key, signing, using the first private key, the first data obtained by parsing, and obtaining second signature data;
generating and saving, by the first device, a second random number, assembling the second signature data and the second random number to obtain a first message, and sending the first message to the second device;
Step S4 comprises:
parsing, by the second device, the first message to obtain the second signature data and second data, performing, using a pre-saved first public key and first random number saved internally, the signature verification on the second signature data obtained by parsing; if the signature verification is successful, the first data parsed by the first device is the first random number generated by the second device, completing the authentication of the first device, saving the second data obtained by parsing and maintaining the Bluetooth connection; if the verification fails, returning the authentication failure response and disconnecting the Bluetooth connection.

8. The method according to claim 7, wherein Step S4 specifically comprises:
parsing, by the second device, the first message to obtain the second signature data and the second data, decrypting, using a pre-saved first public key, the second signature data obtained by parsing, to obtain a first hash value;
performing, by the second device, a hash operation on the first random number saved internally to obtain a second hash value;
determining, by the second device, whether the first hash value is the same as the second hash value; if they are the same, the signature verification is successful, the first data obtained by parsing by the first device is the first random number generated by the second device, completing the authentication of the first device, saving the second data obtained by parsing, and maintaining the Bluetooth connection; if they are not the same, the signature verification fails, and returning the authentication failure response and disconnecting the Bluetooth connection.

9. The method according to claim 7, wherein the target data is specifically the second data obtained by parsing, and Step S6 comprises:
signing, by the second device, using a pre-saved second private key, the second data obtained by parsing, to generate third signature data, and returning the third signature data as a response result to the first device;
Step S7 comprises:
performing, by the first device, the signature verification on the third signature data using a pre-saved second public key and the second random number saved internally; if the signature verification is successful, the second data obtained by parsing through the second device is the second random number generated by the first device, maintaining the Bluetooth connection and completing the authentication of the second device; if the verification fails, returning the authentication failure response and disconnecting the Bluetooth connection.

10. A device authentication apparatus based on a Bluetooth connection, the apparatus is applied to a first device and a second device, wherein the apparatus comprises a memory, a processor, and a computer program stored on the memory and executable on the processor, wherein the processor is configured to:
parse Bluetooth broadcast data scanned by the first device, and determine Bluetooth broadcast data corresponding to the second device according to a Bluetooth name obtained by parsing; wherein the Bluetooth broadcast data corresponding to the second device comprises a first random number generated by the second device;
parse the Bluetooth broadcast data corresponding to the second device to obtain first data, and establish the Bluetooth connection between the first device and the second device;
generate to-be-verified data according to the first data obtained by parsing, and send the to-be-verified data to the second device;
verify the to-be-verified data using a first random number saved in the second device; if a verification is successful, determine that the first data obtained by parsing is the first random number generated by the second device, maintain the Bluetooth connection, and complete authentication of the first device; if the verification fails, return an authentication failure response and disconnect the Bluetooth connection;
send a request for Bluetooth characteristic value processing to the second device, wherein the Bluetooth characteristic value processing comprises reading a Bluetooth characteristic value and writing the Bluetooth characteristic value;
obtain target data, sign the target data to generate a signature result, and return the signature result as a response result to the first device;
perform a signature verification on the signature result; if the signature verification is successful, maintain the Bluetooth connection and complete the authentication of the second device; if the signature verification fails, return the authentication failure response and disconnect the Bluetooth connection.

11. A non-transitory computer-readable storage medium, storing a computer program, wherein the computer program implements steps of methods according to claim 1 when executed by a processor.

12. (canceled)

13. The apparatus according to claim 10, wherein the processor is further configured to:
parse the Bluetooth broadcast data corresponding to the second device to obtain a first ciphertext, decrypt the first ciphertext through using a first private key saved internally to obtain the first data, and establish the Bluetooth connection between the first device and the second device;
obtain to-be-processed business data, and perform padding processing on the business data through using a preset padding rule, encrypt the padded business data through using the first data obtained by decrypting to obtain a second ciphertext, and send the second ciphertext to the second device;
decrypt the second ciphertext through using the first random number saved by the second device, if a decryption is successful, determine whether decrypted data complies with the preset padding rule; if it does, complete the authentication of the first device, maintain the Bluetooth connection, and perform business processing according to the decrypted data; if it does not comply, return the authentication failure response and disconnect the Bluetooth connection; if the decryption fails, return the authentication failure response and disconnect the Bluetooth connection.

14. The apparatus according to claim 10, wherein the target data is specifically a first time, and the processor is further configured to:
obtain the first time, sign the first time through using a private key saved internally to generate first signature data, and return the first signature data as the response result to the first device; wherein the first time is a current time of the second device;
obtain a second time, perform the signature verification on the first signature data through using a pre-saved second public key and the second time; if the signature verification is successful, maintain the Bluetooth connection and complete the authentication of the second device; if the signature verification fails, return the authentication failure response and disconnect the Bluetooth connection, wherein the second time is the current time of the first device.

15. The apparatus according to claim 13, wherein the processor is further configured to:
generate and save a first random number;
encrypt the first random number through using a pre-saved first public key to obtain a ciphertext of the first random number;
organize the Bluetooth broadcast data according to the ciphertext of the first random number, enable Bluetooth broadcast, and broadcast the Bluetooth broadcast data.

16. The apparatus according to claim 15, wherein after establishing a Bluetooth connection between the first device and the second device, the processor is further configured to:
turn off the Bluetooth broadcast, regenerate and save a new first random number;
encrypt the new first random number through using the pre-saved first public key to obtain a ciphertext of the new first random number; and
organize the Bluetooth broadcast data according to the ciphertext of the new first random number, enable Bluetooth broadcast, and broadcast the Bluetooth broadcast data.

17. The apparatus according to claim 10, wherein the processor is further configured to:
perform a Bluetooth paring between the first device and the second device; if the pairing is successful:
establish a one-way Bluetooth connection between the first device and the second device,
call a target interface for the Bluetooth connection; if a connection is successful, establish a bidirectional Bluetooth connection between the first device and second device, generate the to-be-verified data according to the first data obtained by parsing and send the to-be-verified data to the second device; otherwise, return a bidirectional Bluetooth connection failure response, generate the to-be-verified data according to the first data obtained by parsing and send the to-be-verified data to the second device;
otherwise, return the authentication failure response.

18. The apparatus according to claim 10, wherein the processor is further configured to:
obtain a pre-saved first private key, sign the first data obtained by parsing through using the first private key, and obtain second signature data;
generate and save a second random number, assemble the second signature data and the second random number to obtain a first message, and send the first message to the second device;
parse the first message to obtain the second signature data and the second data, perform the signature verification on the second signature data obtained by parsing through using a pre-saved first public key and internally saved first random number; if the signature verification is successful, the first data parsed by the first device is the first random number generated by the second device, complete the authentication of the first device, save the second data obtained by parsing and maintain the Bluetooth connection; if the verification fails, return the authentication failure response and disconnect the Bluetooth connection.

19. The apparatus according to claim 18, wherein the processor is further configured to:
parse the first message to obtain the second signature data and the second data, decrypt the second signature data obtained by parsing through using a pre-saved first public key, and obtain a first hash value;
perform a hash operation on the internally saved first random number to obtain a second hash value;
determine whether the first hash value is the same as the second hash value; if they are the same, the signature verification is successful, the first data obtained by parsing by the first device is the first random number generated by the second device, complete the authentication of the first device, save the second data obtained by parsing, and maintain the Bluetooth connection; if they are not the same, the signature verification fails, and return the authentication failure response and disconnect the Bluetooth connection.

20. The apparatus according to claim 18, wherein the target data is specifically the second data obtained by parsing, and the processor is further configured to:
sign the second data obtained by parsing through using a pre-saved second private key to generate third signature data, and return the third signature data as a response result to the first device;
perform the signature verification on the third signature data through using a pre-saved second public key and the internally saved second random number; if the signature verification is successful, the second data obtained by parsing through the second device is the second random number generated by the first device, maintain the Bluetooth connection and complete the authentication of the second device; if the verification fails, return the authentication failure response and disconnect the Bluetooth connection.
